(19) United States
(12) Patent Application Publication
(10) Pub. No.: US 2024/0206493 A1
(43) Pub. Date: Jun. 27, 2024

(54) EDIBLE VEGETABLE FAT AND OIL

(71) Applicant: KUKI SANGYO CORPORATION, Mie (JP)

(72) Inventors: Sendai HARADA, Mie (JP); Daiki KATO, Mie (JP)

(21) Appl. No.: 18/288,377

(22) PCT Filed: Apr. 25, 2022
(86) PCT No.: PCT/JP2022/018768

§ 371 Date: Oct. 25, 2023

(30) Foreign Application Priority Data
Apr. 26, 2021 (JP) 2021-074434

(51) Int. Cl. A23D 9/007; A23L 27/20

(52) U.S. Cl. CPC A23D 9/007; A23L 27/2052; A23L 27/2054

(57) ABSTRACT

To provide an edible vegetable fat and oil having an enhanced scent of sesame oil. This edible vegetable fat and oil has a scent of sesame oil and contains 2-methylpyrazine, dimethylpyrazine, 2-furanmethanol, furfural, and pyrazine. A content of 2-methylpyrazine is 6 μg or more in 100 mg of the edible vegetable fat and oil and is larger than a content of dimethylpyrazine and a content of 2-furanmethanol. A content ratio of dimethylpyrazine to 2-methylpyrazine is from 0.40 to 0.90.

### TECHNICAL FIELD

The present invention relates to an edible vegetable fat and oil having a scent of sesame oil.

### BACKGROUND ART

Sesame is known as a food containing components such as sesamin, in addition to dietary fibers, calcium, iron, zinc, and other components, having a high nutritive value, and also having excellent functionalities such as an antioxidative property. Sesame is widely used in the forms of sesame oil, roasted sesame, ground sesame, paste sesame, or the like for both household and professional uses.

A fragrant scent characteristic of sesame oil is expected to increase appetite of consumers, and sesame oil is often used for imparting the scent. Sesame oil is a kind of edible oils having a unique scent and flavor, and has a wide range of uses such as deep-frying oil, stir-frying oil, and dressings. In recent years, various sesame oils have been commercially available due to diversifying preferences of consumers. Many mixed oils blending rapeseed oil, soybean oil, and the like with sesame oil are also commercially available, and a market of edible vegetable fats and oils having a scent and flavor of sesame oil is expanding.

Conventionally, the scent of sesame oil has been analyzed, and sesame oil is known to contain various scent components (Non-Patent Document 1). In recent years, many seasonings containing sesame have also been studied, and attempts to maintain the scent of sesame oil for a long period of time have also been carried out by blending a specific scent agent (for example, Patent Document 1).

### PRIOR ART DOCUMENTS

### Patent Document

Patent Document 1: JP 2008-154476 A

### Non Patent Document

Non-Patent Document 1: Journal of Japan Oil Chemists' Society, Vol. 47, No. 3, 1998, pp. 257-261

### SUMMARY OF THE INVENTION

### Problems to be Solved by the Invention

In particular, edible vegetable fats and oils having a strong scent of sesame oil are suitable for, for example, imparting the scent to cooking, and it can be said that demand for such fats and oils has increased in recent years. Although research has been carried out on the scent of sesame oil, there is still room for improvement in enhancing the scent of sesame oil in edible vegetable fats and oils.

The present invention has been made in view of the aforementioned circumstances and has an object to provide an edible vegetable fat and oil having an enhanced scent of sesame oil.

### Means for Solving the Problem

An edible vegetable fat and oil of the present invention is an edible vegetable fat and oil having a scent of sesame oil and containing 2-methylpyrazine, dimethylpyrazine, and 2-furanmethanol, and a content of the 2-methylpyrazine is 6 μg or more in 100 mg of the edible vegetable fat and oil and is larger than a content of the dimethylpyrazine and a content of the 2-furanmethanol.

Note that in the present description, the content of each component refers to a content in 100 mg of an edible vegetable fat and oil. Dimethylpyrazine is a concept including 2,5-dimethylpyrazine, 2,6-dimethylpyrazine, and 2,3-dimethylpyrazine, and the content of dimethylpyrazine refers to the total amount of these components. It is relatively difficult to detect each of these components as separate peaks in HPLC, and the present invention specifies the content as a sum of these components. Note that the edible vegetable fat and oil of the present invention contains at least one of 2,5-dimethylpyrazine, 2,6-dimethylpyrazine, and 2,3-dimethylpyrazine.

A content ratio of the dimethylpyrazine to the 2-methylpyrazine is from 0.40 to 0.90. In addition, a mass ratio between the dimethylpyrazine and the 2-furanmethanol is from 70:30 to 40:60.

The edible vegetable fat and oil further contains furfural and pyrazine.

A content ratio of the furfural to the 2-methylpyrazine is 0.20 or smaller.

### Effects of the Invention

An edible vegetable fat and oil of the present invention has a scent of sesame oil and contains 2-methylpyrazine, dimethylpyrazine, and 2-furanmethanol, and the content of the 2-methylpyrazine is 6 μg or more in 100 mg of the edible vegetable fat and oil and is larger than the content of the dimethylpyrazine and the content of the 2-furanmethanol. This results in an edible vegetable fat and oil having a more powerful scent (stronger scent power) than that of commercially available sesame oil while maintaining a fragrant scent characteristic of sesame oil.

The content ratio of the dimethylpyrazine to the 2-methylpyrazine is from 0.40 to 0.90, and the mass ratio between the dimethylpyrazine and the 2-furanmethanol is from 70:30 to 40:60, and thus the scent typical of sesame oil can be easily maintained.

The edible vegetable fat and oil described above further contains a predetermined content of furfural (having an almond-like scent). This results in an edible vegetable fat and oil having a rich scent more typical of sesame oil.

### BRIEF DESCRIPTION OF THE DRAWINGS

FIG. 1 includes graphs illustrating contents of scent components in Examples 1 to 3 and Comparative Example 1.

FIG. 2 is a graph illustrating contents of scent components in Reference Examples 1 to 5.

FIG. 3 is a graph illustrating content ratios between specific components in each test example.

FIG. 4 includes graphs illustrating contents of scent components in Example 4 and Example 5.

### MODE FOR CARRYING OUT THE INVENTION

As a result of intensive studies to obtain an edible vegetable fat and oil having an enhanced scent of sesame oil, the inventors of the present invention have found that the scent can be enhanced, while maintaining the scent characteristic of sesame oil, by containing a predetermined or larger amount of 2-methylpyrazine, which is conventionally known as one of the scent components of sesame oil, and further containing a specific ratio of dimethylpyrazine and 2-furanmethanol or the like in the edible vegetable fat and oil. The present invention is based on such finding.

The edible vegetable fat and oil of the present invention is an edible vegetable fat and oil having a scent of sesame oil. This edible vegetable fat and oil can also be used, in addition to sesame oil, as soybean oil, rapeseed oil, rice oil, corn oil, palm oil, coconut oil, sunflower oil, olive oil, cotton seed oil, and safflower oil. Preferably, this edible vegetable fat and oil is used as sesame oil.

The edible vegetable fat and oil of the present invention contains at least 2-methylpyrazine, dimethylpyrazine, and 2-furanmethanol, as scent components.

2-Methylpyrazine is a compound having a nut-like or cocoa-like scent, and is a component produced by roasting coffee and cacao. The content of 2-methylpyrazine in the edible vegetable fat and oil of the present invention is 6 μg or more. As illustrated with reference to examples below, contents of 2-methylpyrazine in commercially available sesame oils are about 2 μg to 3 μg at most. The edible vegetable fat and oil of the present invention contains about more than twice as much 2-methylpyrazine as those oils.

The content of 2-methylpyrazine in the edible vegetable fat and oil is preferably 10 μg or more, and more preferably 20 μg or more. The upper limit of the content of 2-methylpyrazine is not limited but is 100 g or lower, for example, and may be 70 μg or lower. Note that the content of 2-methylpyrazine in the edible vegetable fat and oil can be measured using a high-performance liquid chromatography (HPLC) by methods such as those described in the examples. The same applies to dimethylpyrazine, 2-furanmethanol, furfural, pyrazine, and the like.

Dimethylpyrazine, which is another essential component in the edible vegetable fat and oil of the present invention, has a nut-like or cocoa-like scent. 2-Furanmethanol (furfuryl alcohol) is a compound having a roast-like scent. The content of each of these is smaller than the content of 2-methylpyrazine. When the content of each of these is larger than the content of 2-methylpyrazine, the scent components become imbalanced and the scent characteristic of sesame oil is lost, as demonstrated in the examples.

The ratio of the content of dimethylpyrazine to the content of 2-methylpyrazine (the content of dimethylpyrazine/the content of 2-methylpyrazine) in the edible vegetable fat and oil is preferably from 0.40 to 0.90, more preferably from 0.40 to 0.80, and even more preferably from 0.40 to 0.70. Setting the value within the above-described ranges results in the scent typical of sesame oil. A specific content of dimethylpyrazine is, for example, from 1.5 μg to 50 μg.

The ratio of the content of 2-furanmethanol to the content of 2-methylpyrazine (the content of 2-furanmethanol/the content of 2-methylpyrazine) in the edible vegetable fat and oil is preferably from 0.30 to 0.90, and more preferably from 0.30 to 0.80. A specific content of 2-furanmethanol is, for example, from 2.0 μg to 50 μg.

A mass ratio between dimethylpyrazine and 2-furanmethanol is, for example, from 70:30 to 40:60, and preferably from 55:45 to 45:55. About the same degree of contents of both components makes it easier to exhibit the scent characteristic of sesame oil.

The edible vegetable fat and oil of the present invention preferably further contains furfural and pyrazine, as scent components. Furfural is a kind of aromatic aldehydes and is a compound having an almond-like scent. Pyrazine is a compound having a roast-like scent. The content of pyrazine is, for example, from 0.5 μg to 10 μg. The content of the pyrazine is preferably larger than that of furfural, and preferably smaller than the content of dimethylpyrazine and the content of 2-furanmethanol.

The ratio of the content of furfural to the content of 2-methylpyrazine (the content of furfural/the content of 2-methylpyrazine) in the edible vegetable fat and oil is preferably 0.20 or smaller, and more preferably 0.10 or smaller. A specific content of furfural is, for example, from 0.3 μg to 3 μg.

In addition to the scent components described above, the edible vegetable fat and oil of the present invention may also contain scent components found in usual sesame oil. For example, trimethyl pyrazine, 2-ethyl-5-methylpyrazine, 2-ethyl-6-methylpyrazine, 2-acetylpyrazine, pentanal, hexanal, heptanal, 2-pentylfuran, 2,4-dimethylthiazole, or the like may be contained. Other scent components may be further contained within a range that does not impair the advantageous effects of the present invention.

In the edible vegetable fat and oil of the present invention, methods for adjusting the content of the components described above, such as 2-methylpyrazine, are not limited. For example, commercially available products may be used as the components, or scent agents containing the components may be used. In this case, the edible vegetable fat and oil of the present invention can be obtained by, for example, adding a predetermined amount of each component to existing sesame oil or the like.

Here, sesame oil is generally produced through a roasting step, a pressing step, and a filtration step. As sesame for the raw material, white sesame, black sesame, golden sesame, yellow sesame, brown sesame, and the like are used, and sorted according to various criteria (size, weight, and the like).

Roasting the sorted raw sesame produces a fragrant scent characteristic of sesame oil. Roasting machines and roasting methods in the roasting step are not limited. As the roasting machines, for example, continuous-type roasting machines and other batch-type roasting machines can be used. As the roasting methods, direct fire, hot air, far-infrared rays, microwave, or the like can be used, and the roasting is carried out at about 150° C. to 250° C. Roasted sesame is put in a pot and boiled in the pot by steam. Subsequently, the roasted sesame is pressed with a pressing machine to squeeze out oil. The squeezed oil is left to stand and then filtered to remove solids and sediments. Filtration operations are normally carried out multiple times. Finally, sesame oil is obtained.

The edible vegetable fat and oil of the present invention can also be obtained by contacting scent components generated in the sesame oil production process described above with a target oil (for example, an edible vegetable fat and oil in a production line different from the sesame oil described above). In this case, soybean oil, rapeseed oil, rice oil, corn oil, palm oil, coconut oil, sunflower oil, olive oil, cottonseed oil, safflower oil, or the like can be used as an edible vegetable fat and oil to be contacted, in addition to sesame oil.

The edible vegetable fat and oil of the present invention can be used not only as cooking oils and dressings at home and elsewhere, but also as additives in various processed foods. For example, the edible vegetable fat and oil may be used by mixing, kneading, or the like with various kinds of foods such as cereal foods, powdered soups, breads, cakes, noodles, confectioneries, jellies, frozen foods, ice creams, dairy products, or beverages.

The edible vegetable fat and oil of the present invention has an enhanced scent of sesame oil and, even by a small amount, can sufficiently impart the scent of sesame oil. Thus, the amount used of an edible vegetable fat and oil itself can be reduced, leading to calorie reduction of cooking and lower-calorie products. In addition, when the edible vegetable fat and oil of the present invention is dispersed in soup or the like, the deliciousness of the after taste increases and a rich taste imparting effect is also expected. In particularly, in “salt reduction products” the market expansion of which is expected, there are many products enhancing deliciousness and rich taste instead of using salt and this edible vegetable fat and oil can be applied to the market targeting salt reduction.

### EXAMPLES

### Examples 1 to 3 and Comparative Example 1

As an example of an edible vegetable fat and oil, sesame oil was produced. Sesame as the raw material was produced through each step of roasting, pressing, and filtration. Specifically, production was carried out by roasting sesame at from 150° ° C. to 250° C. for 5 minutes to 15 minutes, oil-squeezing the sesame using a pressing machine, and then filtering solids using a filter press. Note that in an intermediate stage after the pressing, scent components generated in the production process were contacted.

### Reference Examples 1 to 5

In Reference Examples 1 to 4, four types of commercially available dark-type sesame oils were used as comparison targets. In Reference Example 5, a flavor for imparting a scent of sesame oil to seasonings or the like was used.

### <Measurement of Scent Components>

The scent components in Examples 1 to 3, Comparative Example 1, and Reference Examples 1 to 5 were measured by HPLC after the scent components were extracted from each fat and oil according to the following method.

### (1) Extraction of Scent Components

The extraction was carried out according to the following procedure.
1. To 3 g of fat and oil, 3 ml of methanol was added.
2. Ultrasonic extraction was carried out for 10 minutes.
3. Centrifugal separation was carried out at 3500 rpm for 10 minutes.
4. The supernatant was recovered.
5. To the residue, 3 ml of methanol was added.
6. The operations 2 to 5 described above were repeated three times in total.
7. The volume was increased to 10 ml with methanol.
8. The extract after filter filtration was used for the following measurement.

### (2) Quantification of Scent Components

To HPLC, 5 μl of the extract obtained in (1) described above was injected, and quantitative analysis was carried out under the following conditions.

### <HPLC Conditions>

Column: ODS column length 150 mm×column internal diameter 3 mm, particle diameter 3 μm
Oven: 35° ° C.
Detection wavelength: 215 nm, 270 nm
Mobile phase A: 0.1% aqueous formic acid
Mobile phase B: Acetonitrile
Flow rate: 0.43 ml/min
Liquid transfer of each mobile phase: The mixing ratio of the mobile phase A and the mobile phase B was changed as listed in Table 1

TABLE 1

| Analysis time | Mobile phase A | Mobile phase B |
|---|---|---|
| (min) | (%) | (%) |
| 0 | 98.5 | 1.5 |
| 10 | 98.5 | 1.5 |
| 20 | 60 | 40 |
| 21 | 10 | 90 |
| 24.5 | 10 | 90 |
| 25.5 | 98.5 | 1.5 |
| 40 | 98.5 | 1.5 |

The quantification of scent components was carried out by the standard addition method using peak areas detected by HPLC. Measurement was carried out under the HPLC conditions described above by using a sample of each scent component, which had been diluted with methanol, as a quantitative marker. In the examples, the content of dimethylpyrazine was calculated as the total content of 2,5-dimethylpyrazine and 2,6-dimethylpyrazine.

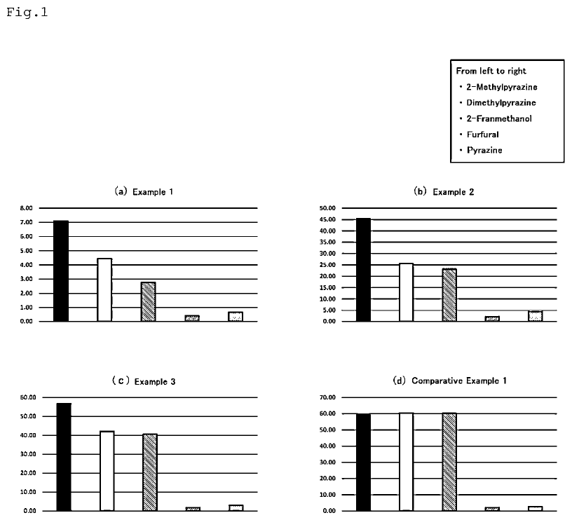

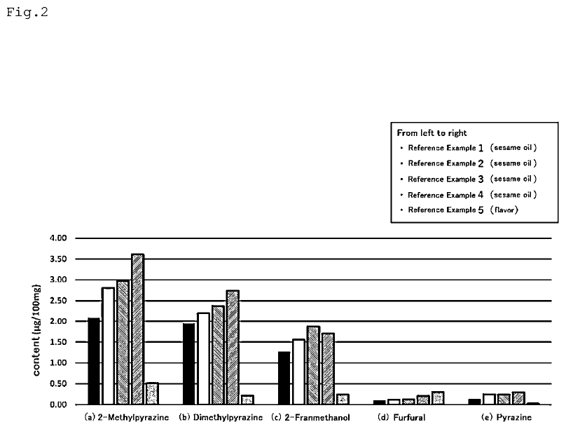

In addition, sensory evaluation was carried out on the sesame oils in Examples 1 to 3 and Comparative Example 1. In the sensory evaluation, the scent of the sesame oil in Reference Example 2 was used as the standard, and the evaluation was carried out on two points: the strength of the scent and whether the scent was typical of sesame oil compared to the standard sesame oil. The results are listed in Table 2 and Table 3. Graphs illustrating the contents of the scent components in Examples 1 to 3 and Comparative Example 1 in Table 2 are illustrated in FIG. 1, and a graph illustrating the contents of the scent components in Reference Examples 1 to 5 in Table 3 is illustrated in FIG. 2.

TABLE 2

| | | | | | | | Comparative |
|---|---|---|---|---|---|---|---|
| | | Example 1 | Example 2 | Example 3 | Example 4 | Example 5 | Example 1 |
| Content | (a) | 7.10 | 45.40 | 56.77 | 25.14 | 19.77 | 59.16 |
| (μg/100 mg) | 2-Methylpyrazine | | | | | | |
| | (b) | 4.46 | 25.53 | 42.07 | 17.60 | 8.69 | 60.40 |
| | Dimethylpyrazine | | | | | | |
| | (c) | 2.75 | 23.11 | 40.58 | 10.76 | 10.45 | 60.16 |
| | 2-Franmethanol | | | | | | |
| | (d) Furfural | 0.41 | 2.17 | 1.73 | 1.05 | 1.22 | 2.10 |
| | (e) Pyrazine | 0.66 | 4.43 | 2.99 | 3.16 | 1.62 | 2.60 |
| Content | (b)/(a) | 0.63 | 0.56 | 0.74 | 0.70 | 0.44 | 1.02 |
| ratio | (c)/(a) | 0.39 | 0.51 | 0.71 | 0.43 | 0.53 | 1.02 |
| | (d)/(a) | 0.06 | 0.05 | 0.03 | 0.04 | 0.06 | 0.04 |
| | (b):(c) | 62:38 | 52:48 | 51:49 | 62:38 | 45:55 | 50:50 |
| Sensory | Strength of | Strong | Considerably | Considerably | Considerably | Considerably | Considerably |
| evaluation | scent | | strong | strong | strong | strong | strong |
| | Scent typical of sesame oil | [symbol] | [symbol] | [symbol] | [symbol] | [symbol] | x |

TABLE 3

| | | Reference | Reference | Reference | Reference | Reference |
|---|---|---|---|---|---|---|
| | | Example 1 | Example 2 | Example 3 | Example 4 | Example 5 |
| Content | (a) | 2.08 | 2.81 | 2.97 | 3.61 | 0.52 |
| (μg/100 mg) | 2-Methylpyrazine | | | | | |
| | (b) | 1.95 | 2.19 | 2.37 | 2.74 | 0.22 |
| | Dimethylpyrazine | | | | | |
| | (c) | 1.26 | 1.55 | 1.87 | 1.70 | 0.24 |
| | 2-Franmethanol | | | | | |
| | (d) Furfural | 0.10 | 0.11 | 0.12 | 0.21 | 0.30 |
| | (e) Pyrazine | 0.13 | 0.25 | 0.24 | 0.29 | 0.02 |
| Content | (b)/(a) | 0.94 | 0.78 | 0.80 | 0.76 | 0.42 |
| ratio | (c)/(a) | 0.61 | 0.55 | 0.63 | 0.47 | 0.47 |
| | (d)/(a) | 0.05 | 0.04 | 0.04 | 0.06 | 0.58 |
| | (b):(c) | 61:39 | 59:41 | 56:44 | 62:38 | 47:53 |
| Sensory | Strength of scent | — | Average | — | Somewhat | — |
| evaluation | | | | | strong | |
| | Scent typical of sesame oil | — | [symbol] | — | [symbol] | — |

As listed in Table 2, the sesame oils in Examples 1 to 3 each contained 6 μg or more of 2-methylpyrazine, and the content was larger than the content of dimethylpyrazine and the content of 2-furanmethanol, resulting in a stronger scent of sesame oil than that of commercially available sesame oil, while maintaining the scent of sesame oil. On the other hand, Comparative Example 1 provided a very strong scent, but the scent was different from the scent typical of sesame oil. As seen from each graph in FIG. 1, Comparative Example 1 has a higher content ratio of dimethylpyrazine to 2-methylpyrazine and a higher content ratio of 2-furanmethanol to 2-methylpyrazine than in Examples 1 to 3. Thus, a fragrant scent characteristic of sesame oil is considered to have been lost due to imbalance between the scent components.

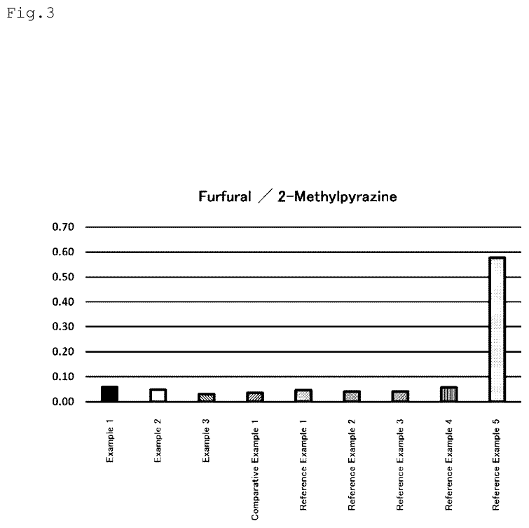

As listed in Table 3 and illustrated in FIG. 2, in the commercially available sesame oils (Reference Examples 1 to 4), the component balance was approximately the same, although there were some differences in the content of each component. In terms of flavor, the ratio of the content of furfural to the content of 2-methylpyrazine differed significantly from those in the other test examples, as illustrated in FIG. 3.

### Example 4 and Example 5

The sesame oil in Example 4 was produced in the same manner as in Examples 1 to 3 described above. The soybean oil in Example 5 was produced by contacting scent components generated in a production process of sesame oil with commercially available soybean oil.

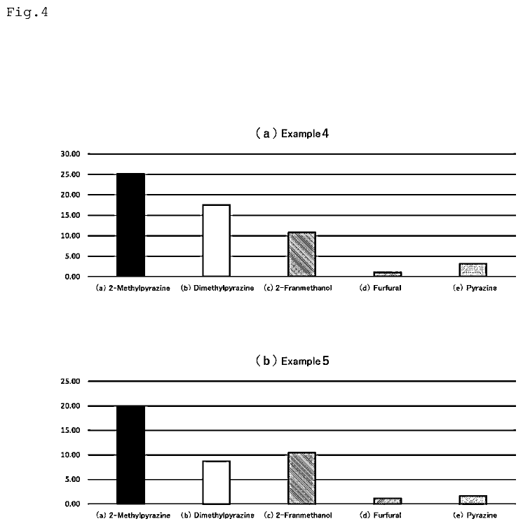

The results in which the scent components in the sesame oil and the soybean oil in Example 4 and Example 5 were analyzed as described above are listed in Table 2 and illustrated in FIG. 4. As illustrated in FIGS. 4 (a) and 4(b), both of these oils contained more than 10 μg of 2-methylpyrazine and exhibited component balance similar to those in Examples 1 to 3 in FIG. 1. In fact, the oils in Example 4 and Example 5 provided a stronger scent than that of commercially available sesame oil (Reference Example 2). It has been found that the fragrant scent characteristic of sesame oil can be imparted to even vegetable fats and oils other than sesame oil by containing certain components.

### INDUSTRIAL APPLICABILITY

The edible vegetable fat and oil of the present invention has an enhanced scent of sesame oil, and thus can simply impart the fragrant scent characteristic of sesame oil to cooking and the like and can be widely used in cooking oils, dressings, addition to processed foods, and the like.

1. An edible vegetable fat and oil having a scent of sesame oil, the edible vegetable fat and oil comprising:
2-methylpyrazine, dimethylpyrazine, and 2-franmethanol, wherein
a content of the 2-methylpyrazine is 6 μg or more in 100 mg of the edible vegetable fat and oil and is larger than a content of the dimethylpyrazine and a content of the 2-furanmethanol.

2. The edible vegetable fat and oil according to claim 1, wherein a content ratio of the dimethylpyrazine to the 2-methylpyrazine is from 0.40 to 0.90.

3. The edible vegetable fat and oil according to claim 2, wherein a mass ratio between the dimethylpyrazine and the 2-furanmethanol is from 70:30 to 40:60.

4. The edible vegetable fat and oil according to claim 1, further comprising: furfural and pyrazine.

5. The edible vegetable fat and oil according to claim 4, wherein a content ratio of the furfural to the 2-methylpyrazine is 0.20 or smaller.

6. The edible vegetable fat and oil according to claim 1, wherein
the content of the 2-methylpyrazine is from 10 μg to 100 μg in 100 mg of the edible vegetable fat and oil,
a content ratio of the dimethylpyrazine to the 2-methylpyrazine is from 0.40 to 0.70, and
a mass ratio between the dimethylpyrazine and the 2-furanmethanol is from 55:45 to 45:55.

7. The edible vegetable fat and oil according to claim 6, further comprising:
furfural and pyrazine, wherein
a content ratio of the furfural to the 2-methylpyrazine is 0.20 or smaller, and
a content of the pyrazine is larger than a content of the furfural and is smaller than the content of the dimethylpyrazine and the content of the 2-furanmethanol.

8. The edible vegetable fat and oil according to claim 2, further comprising:
furfural and pyrazine.

9. The edible vegetable fat and oil according to claim 3, further comprising:
furfural and pyrazine.
